(19) United States
(12) Patent Application Publication
(10) Pub. No.: US 2026/0324909 A1
(43) Pub. Date: Oct. 22, 2026

(54) MAGNETICALLY MOUNTED SHOWER ITEMS

(71) Applicant: Empower Independence Company Inc., Omaha, NE (US)

(72) Inventors: Kelly Van Ert, Omaha, NE (US); Wesley Van Ert, Omaha, NE (US); John D. Martin, Seattle, WA (US); Zachary D. West, Seattle, WA (US); Daniel D. Herbert, Seattle, WA (US)

(21) Appl. No.: 19/468,160

(22) Filed: Feb. 3, 2026

Related U.S. Application Data
(60) Provisional application No. 63/753,148, filed on Feb. 3, 2025.

(51) Int. Cl. A47K 3/28; B05B 1/18; B05B 15/62; B05B 15/63; E03C 1/06; F16B 1/00

(52) U.S. Cl. CPC A47K 3/281; B05B 1/18; B05B 15/62; B05B 15/63; E03C 1/06; F16B 1/00; F16B 2200/83

(57) ABSTRACT

Systems and devices for magnetically mounting shower items, such as personal hygiene items or accessories, onto the walls of a showering or bathing area using one or more magnetic mounting boards (or magnetic board) mounted on the walls. The magnetic board may be mounted to be movable between a first position and a second position.

### PRIORITY

This application claims the benefit of priority to U.S. application Ser. No. 63/753148 filed on Feb. 3, 2025, the entire contents of which are incorporated herein by reference.

### FIELD

This technical disclosure relates to systems and devices for magnetically mounting shower items such as personal hygiene items and accessories onto the walls of a showering or bathing area using one or more magnetic mounting boards mounted on the walls together with one or more magnetic elements mounted to the shower items.

### BACKGROUND

Shower items, such as showerheads or bottles of soap are commonly placed in a showering or bathing area (referred to collectively as a shower area). The shower area usually includes at least a showerhead directly mounted to a particular height on the wall or placed in a holder that is mounted to the wall. The shower area can include a shelving unit mounted to the wall for holding other shower items, such as a bottle of soap or shampoo.

U.S. Pat. No. 11,998,146 describes a system for magnetically mounting shower items in a shower area in place of or in addition to locating shower items on a shelving unit of the shower area.

### SUMMARY

This technical disclosure relates to systems and devices for magnetically mounting shower items, such as personal hygiene items and/or accessories, onto the walls of a showering or bathing area using one or more magnetic mounting boards (or magnetic board) mounted on the walls. Shower items that can be mounted on the magnetic board can be any items used in a shower including, but not limited to, a showerhead, a bottle of soap, shampoo, or conditioner, a bar of soap, a long-handled sponge, a razor, a mirror, a loofah, a washcloth, a toothbrush, toothpaste, mouthwash, or the like. One or more magnets mounted on the shower item serve to allow magnetic attachment of the shower item to the magnetic board.

In an embodiment, a magnetic board can be mounted on a shower or bathing area wall in a manner to allow the magnetic board to be moved between a lowered position and a raised position. In an embodiment, the magnetic board may be mounted to a grab bar. A locking mechanism can be provided to releasably lock the magnetic board at the lowered position or at the raised position. When the locking mechanism is in a locked position, the magnetic board is locked at its current lowered or raised position. When the locking mechanism is actuated to a release position, the magnetic board can be actuated from its current position to the other of the raised or lowered position.

In an embodiment, the magnetic board may also be lockable at an intermediate position between the lowered and raised positions by the locking mechanism. The intermediate position may be a horizontal position where the magnetic board extends horizontally from the wall and forms a horizontal magnetic table.

In an embodiment, the magnetic board may be made of a material that is magnetic which renders the entire magnetic board magnetic. Both the front surface of the magnetic board and the rear surface of the magnetic board are magnetic thereby allowing a shower item to be magnetically mounted to either the front surface or to the rear surface. In an embodiment, the entire area of the front surface and the entire area of the rear surface may be magnetic. This allows the shower item with one or magnets mounted thereon to be magnetically mounted anywhere on the front or rear surfaces of the magnetic board.

The different possible positions of the magnetic board, together with the flexibility of mounting the shower items anywhere on the front or rear surfaces of the magnetic board, can provide mounting locations in the shower individualized to the user and thus improve user accessibility and safety. For example, it may be more comfortable and safer for a user who has to sit in the shower to move magnetic board to the lowered position, and position the shower items at a desired position on the lowered magnetic board. The lower position of the magnetic board reduces the need for the user to reach up or stand-up in the shower to reach a shower item. Alternatively, it may be more comfortable and safer for a user who stands in the shower to move the magnetic board to the raised position, and position the shower items at a desired position on the raised magnetic board. The higher position of the magnetic board reduces the need for the user to bend over and reach down for items in the shower. If the magnetic board is lockable at an intermediate position, such as at a horizontal position, the user may find the intermediate position to be more convenient for their needs in the shower.

The options of moving the magnetic board to different positions, and locating the shower item(s) to any desired mounting position(s) on the magnetic board, according to individual needs of the user can promote shower safety and independence especially for users with limited mobility, such as elderly adults or people with disabilities. For example, users that can benefit from moving the magnetic board and the magnetically mounted shower items to their desired locations may have limited mobility for reasons such as: arthritis, carpal tunnel, reduced functional grasp, weak hands, decreased shoulder movement, generalized weakness, or the like.

In an embodiment, the front surface, the rear surface, or both the front and rear surfaces of the magnetic board may have flanges that extend upward from side and/or front edge edges thereof. The flanges can help to strengthen the magnetic board, help space the surface from the wall when the magnetic is at its lowered or raised positions, and help retain shower items on the surface.

In an embodiment, a magnetic board described herein may be attached by collars to a grab bar that allow the magnetic board to swing relative to the grab bar between first and second positions with respect to the grab bar. In an embodiment, the first and second positions may be a lowered position relative to the grab bar and a raised position relative to the grab bar, and the grab bar may be oriented horizontally on the shower wall. In another embodiment, the first and second positions may be a first lateral position relative to the grab bar and a second lateral position relative to the grab bar, and the grab bar may be oriented vertically on the shower wall.

In an embodiment, a magnetic board described herein may be attached to a grab bar by one or more pivots and a biasing spring may act on the magnetic board to resiliently bias the magnetic board toward the wall.

In an embodiment, a magnetic board described herein may be formed by a perforated magnetic plate. Perforations of the perforated magnetic plate may extend over an entire area of the magnetic plate.

In an embodiment, a magnetic board described herein may be mounted to a first grab bar that is attached to the wall, and a second grab bar may be directly attached to the magnetic board.

In an embodiment, stand-offs may be attached to a magnetic board described herein to space the magnetic board from the wall. The stand-offs may be adjustable in length.

In an embodiment, the shower item may be a hand-held shower head, and the shower head may be magnetically attachable to the magnetic board by one or more magnets mounted on the shower head. In another embodiment, the shower head may be magnetically attachable to the magnetic board by a cuff that is located at a base of a handle of the hand-held shower head.

In an embodiment, the shower item may be a bottle that is configured to contain soap, shampoo, conditioner or other liquid/gel. The bottle may have one or more magnets fixed thereon for magnetically attaching the bottle to the magnetic board. In an embodiment, the magnet(s) may be initially separate from the bottle and suitably attached to the bottle. In another embodiment, the magnet(s) may be embedded or molded into the material of the bottle, for example in the material that forms the main body or the side wall of the bottle, whereby the magnet(s) and the bottle form a single-piece or one-piece construction. The bottle may be configured to be easy to squeeze, tactile marked, gripped, ergonomic designed bottles. The bottles may be configured to be gripped and formed of easy to grip or hydrophobic type materials to increase the user's ability to grasp and manipulate the bottle. In an embodiment, the bottle can be configured as a plastic, malleable bottle that can be detached from the magnetic board and squeezed with one hand or left on the magnetic board and pushed with the user's hand to allow liquids to be pushed out from the bottle. The bottle may include a wide mouth and formed to be easy to open and fill through a screw and/or turn top or bottom piece. The bottle may include tactile symbols or characters, raised text, raised designs, tactile guides or brail markings to optimize use by visually impaired individuals and allow such individuals to identify and decipher the contents (shampoo, conditioner, body wash, shave cream, etc.). The bottle may also include high-contrast, bright, and bold contrasting colors for individuals with low vision to easily distinguish identify and decipher the contents (shampoo, conditioner, body wash, shave cream, etc.). In an embodiment, a grippable sleeve may be disposable around an existing bottle of soap, shampoo, conditioner or other liquid/gel. The grippable sleeve may include a cut-out or opening that in use is intended to be disposed over existing markings on the bottle to allow a user to visually identify the markings on the bottle and thereby identify its contents.

In one embodiment, a magnetic shower item mounting system described herein can include a magnetic board movably mounted to a shower wall, where the magnetic board is movable relative to the shower wall between a first position relative to the shower wall and a second position relative to the shower wall. The magnetic board has a first side surface and a second side surface, and in the first position the first side surface faces away from the shower wall and the second side surface faces the shower wall, and in the second position the second side surface faces away from the shower wall and the first side surface faces the shower wall. In addition, the magnetic board is formed from a magnetic material, and an entire area of the first side surface is magnetic, and an entire area of the second side surface is magnetic, whereby a shower item having at least one magnet disposed thereon can be magnetically attached anywhere on the first side surface or on the second side surface. In this embodiment, the system may or may not include a grab bar.

In another embodiment, a magnetic shower item mounting system described herein can include a grab bar mounted to a shower wall, and a magnetic board movably mounted to the grab bar. The magnetic board is movable relative to the grab bar between a first position relative to the grab bar and a second position relative to the grab bar. The magnetic board has a first side surface and a second side surface, and in the first position the first side surface faces away from the shower wall and the second side surface faces the shower wall, and in the second position the second side surface faces away from the shower wall and the first side surface faces the shower wall. In addition, the magnetic board is formed from a magnetic material, and an entire area of the first side surface is magnetic and an entire area of the second side surface is magnetic, whereby a shower item having at least one magnet disposed thereon can be magnetically attached anywhere on the first side surface or on the second side surface. In this embodiment, the system includes a grab bar. However, in another embodiment, the grab bar is optional.

In another embodiment, a magnetic shower item mounting system described herein can include a magnetic board having a first side surface and a second side surface, and the magnetic board is formed from a magnetic material whereby at least one of the first side surface or the second side surface is magnetic. The system can further include a hand-held shower head that includes a shower head and a handle having a first end attached to the shower head and a second end spaced from the first end, and a mounting cuff. The mounting cuff has a body, a first flange extending from a first side of the body, and a second flange extending from the first side of the body at a position spaced from the first flange. The first flange has an opening therethrough that is sized to allow passage of a hose that is connected to the second end of the handle. The second flange has a slot formed therein that is sized to allow passage of the hose. In addition, one or more magnets are disposed on the body at a second side thereof opposite the first side for use in magnetically attaching the cuff to the magnetic board.

In another embodiment, a mounting cuff that is usable in a magnetic shower item mounting system can include a body, a first flange extending from a first side of the body, and a second flange extending from the first side of the body at a position spaced from the first flange. The first flange has an opening therethrough that is sized to allow passage of a hose that is connectable to an end of a handle of a hand-held shower head. The second flange has a slot formed therein that is sized to allow passage of the hose. In addition, one or more magnets are disposed on the body at a second side thereof opposite the first side, whereby the magnets magnetically attach the body of the mounting cuff to a magnetic board of the magnetic shower item mounting system.

In another embodiment, a mounting cuff that is usable in a magnetic shower item mounting system can include a body, an internally threaded female opening at one end of the body, an externally threaded male protrusion at a second end of the body, and a fluid flow passage through the body from the internally threaded female opening to the externally threaded male protrusion. In addition, one or more magnets are disposed on the body at a side thereof, whereby the magnets magnetically attach the body of the mounting cuff to a magnetic board of the magnetic shower item mounting system.

### DRAWINGS

FIG. 1 is a perspective view of a showering area including a magnetic board, according to an embodiment.

FIG. 2 is a perspective view of the magnetic board of FIG. 1.

FIG. 3 is a cross-sectional view through the magnetic board of FIG. 2.

FIG. 4 is a close-up view of a locking mechanism associated with the magnetic board.

FIG. 5 depicts adjustable stand-offs according to an embodiment that can be used with the magnetic boards described herein.

FIGS. 6A and 6B illustrate another embodiment of a magnetic board that is swingably mounted on a grab bar.

FIG. 7 illustrates another embodiment of a magnetic board that is associated with two or more grab bars.

FIG. 8 illustrates another embodiment of a magnetic board that includes a spring-bias mechanism to bias the magnetic board toward the wall.

FIGS. 9A and 9B illustrates another embodiment of a magnetic board that is perforated and that includes a grab bar mounted directly thereon.

FIG. 10 depicts magnets mounted on a hand-held shower head for magnetically attaching the shower head to a magnetic board.

FIG. 11 depicts a mounting cuff for magnetically attaching the hand-held shower head to a magnetic board.

FIG. 12 is an exploded view of the mounting cuff and the hand-held shower head of

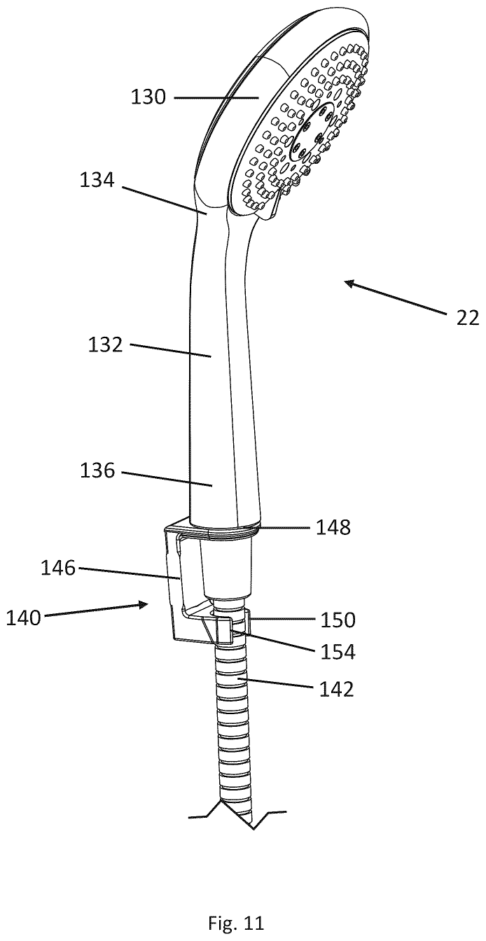

FIG. 11.

FIG. 13 illustrates another example of a mounting cuff.

FIG. 14 is a perspective view of a bottle according to an embodiment described herein.

FIG. 15 depicts a magnetic board that is configured to swing between different lateral positions about a vertical grab bar.

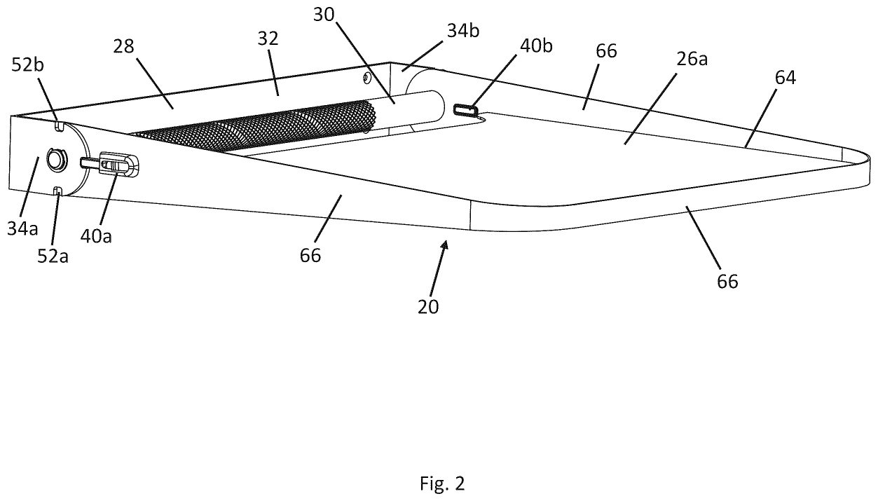

FIG. 16 depicts a magnetic board that is similar to the magnetic board in FIG. 2 but without a grab bar.

FIGS. 17A and 17B depict another embodiment of a magnetic board that uses a different version of stand-offs.

FIGS. 18A and 18B depict another embodiment of a magnetic board that uses another version of stand-offs.

### DETAILED DESCRIPTION

The following is a detailed description of systems and devices for magnetically mounting one or more shower items, such as personal hygiene items accessories, onto the walls of a showering or bathing area using one or more magnetic boards mounted on the walls. The magnetic board may also be referred to as a magnetic mounting board. Shower items that can be mounted on the magnetic board can be any items used in a shower including, but not limited to, a showerhead, a bottle of soap, shampoo, or conditioner, a bar of soap, a long-handled sponge, a razor, a mirror, a loofah, a washcloth, a toothbrush, toothpaste, mouthwash, or the like. One or more magnets mounted on the shower item serve to allow magnetic attachment of the shower item to the magnetic board.

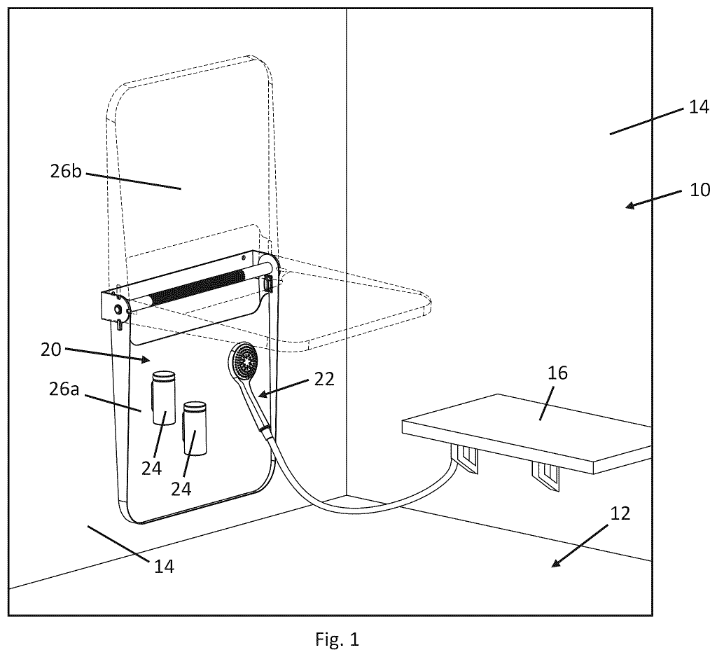

FIG. 1 is a perspective view of an embodiment of a showering area 10 in which the magnetic shower item mounting system described herein can be implemented. As used herein, the term showing area is intended to encompass and include showering as well as bathing or any other facility where a user cleans themselves. The showering area 10 in FIG. 1 is depicted as including a floor 12 that a user stands-on during use, together with shower walls 14 that serve to contain water spray and provide a measure of privacy. There may be one shower wall 14, two shower walls 14, three shower walls 14, four shower walls 14, or any other number of shower walls 14. The floor 12 and the walls 14 can be formed by water-proof material(s) known in the art such as ceramic tiles, plastic panels, or the like. FIG. 1 further depicts an optional seat or bench 16 mounted on one or walls 14 or to the floor 12 upon which a user can sit while showering. Optional water control valve(s) (not shown) may be mounted on one of the walls 14 to allow a user to control the flow of water and regulate the temperature.

With continued reference to FIG. 1, an embodiment of a magnetic board 20 is depicted as being mounted to one of the walls 14. The magnetic board 20 forms a magnetic area on the wall 14 to allow magnetic mounting of one or more shower items, such as, but not limited to, a hand-held shower head 22 and/or one or more bottles 24. The magnetic board 20 together with one or more of the shower items 22, 24 form a magnetic shower item mounting system. Magnetic attraction between the magnetic board and one or more magnets disposed on the shower item holds the shower item in position on the magnetic board 20 without the user actively holding the shower item. The user may remove the shower item from the magnetic board 20 by overcoming the magnetic force, or the user may user the shower item while the shower item remains magnetically attached to the magnetic board 20.

The magnetic board 20 may be made partially or entirely from a magnetic material such that a portion of or the entire board 20 is magnetic. For example, the magnetic board 20 can be formed from a magnetic metal material such as a ferrous metal or a martensitic metal. In an embodiment, the magnetic board 20 can be made from a magnetic stainless steel. In an embodiment, the magnetic board 20 can have a mirror finish to allow the user to view themselves while showering. In an embodiment, an entire area of a first side surface 26a of the magnetic board 20 may be magnetic, and an entire area of a second side surface 26b of the magnetic board 20 may be magnetic. However, in another embodiment, only the first side surface 26a may be magnetic while the second side surface 26b is not magnetic, or only the second side surface 26b may be magnetic while the first side surface 26a is not magnetic, or only a portion of the area of the first side surface 26a and/or a portion of the area of the second side surface 26b may be magnetic.

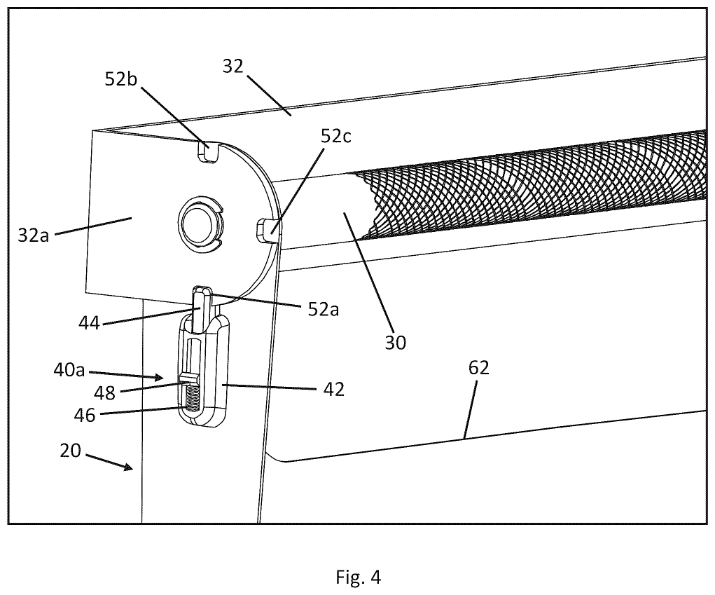

Referring to FIGS. 1-4, the magnetic board 20 is depicted as being movable relative to the shower wall 14 between a first position (in solid lines in FIGS. 1 and 4) relative to the shower wall 14 and a second position (in broken lines in FIG. 1) relative to the shower wall 14. In this embodiment, the first position may be referred to as a lowered position (solid lines in FIGS. 1 and 4) and the second position may be referred to as a raised position (broken lines in FIG. 1), since in the first position the board 20 is positioned lower on the wall than in the second position. In this embodiment, the board 20 pivots about a substantially horizontal pivot axis as it moves between the first and second positions. FIG. 15 depicts an embodiment where the first and second positions are different lateral positions of the board 20 relative to the shower wall, where the board 20 pivots about a substantially vertical pivot axis as it moves between the first and second positions.

The board 20 may be pivotally attached to the wall 14 via a bracket 28 that is fixed to the wall, with the board 20 being pivotable relative to the bracket 28 between the first and second positions. As depicted in FIGS. 1-4, a grab bar 30 may also be attached to the bracket 28. However, the grab bar 30 is optional as depicted in FIG. 16 which is configured the same as the magnetic board 20 in FIGS. 1-4 but without the grab bar. If present, the grab bar 30 may include a roughened texture or include a material such as grip tape connected thereto to enhance grip over a portion of or the entire length of the grab bar 30. The bracket 28 includes a main body 32 and first and second bracket ears 34a, 34b that project outwardly from the main body 32. The main body 32 is fixed to the wall 14 and the ears 34a, 34b project perpendicularly from the main body 32.

When the grab bar 30 is present, the grab bar 30 is fixed to and extends between the ears 34a, 34b whereby the grab bar 30 extends horizontally. The grab bar 30 may be fixed so that it does not rotate with the board 20. As shown in FIGS. 1 and 4, with the horizontal grab bar 30 present and the board 20 in the lowered or first position, the board is vertically below the grab bar 30. With the board 20 in the raised or second position, the board is vertically above the grab bar 30. Alternatively, referring to FIG. 15, the grab bar 30 extends vertically, and the first position is laterally to a first side of the grab bar 30 and the second position is laterally to a second side of the grab bar 30. The magnetic board in FIG. 15 may also have an intermediate position like the intermediate position described below for the magnetic board in FIGS. 1-4. The construction of the magnetic board in FIG. 15 may be otherwise the same as the magnetic board in FIGS. 1-4.

In an embodiment, the board 20 may remain in the first position or the second position via gravity. In another embodiment, the board 20 may include a releasable locking mechanism that is engageable with the board 20 that is configured to releasably lock the board 20 at the first position and configured to releasably lock the board 20 at the second position. The locking mechanism can have any configuration that is suitable for releasably locking the board 20 at the desired position. The locking mechanism should be manually user actuatable to allow a user to manually manipulate the locking mechanism to release the locking mechanism to allow adjustment of the board 20 to a different position.

FIGS. 1-4 illustrate an example of a locking mechanism comprising a detent locking mechanism 40a, 40b on each side of the board 20. The detent locking mechanism 40a, 40b may be identical to one another. In particular, referring to FIG. 4, details of the detent locking mechanism 40a can be seen. The detent locking mechanism 40b may have a similar construction and operation as the detent locking mechanism 40a. As seen in FIG. 4, the detent locking mechanism 40a includes a housing 42 mounted on the board 20. A locking pin 44 extends from an open end of the housing 42, and a biasing spring 46 within the housing 42 acts on the end of the pin 44 and biases the pin 44 outward from the open end of the housing 42. A tab 48 extends from a part of the pin 44 that allows a user to use their finger to retract the pin 44 against the biasing force of the spring 46. Also, the ear 32a includes slots 52a, 52b in the perimeter thereof that are shaped and sized to receive the end of the pin 44. The slot 52a corresponds to the lowered position and releasably locks the board 20 at the lowered position. The slot 52b corresponds to the raised position and releasably locks the board 20 at the raised position.

In operation, the user uses their fingers acting on the tabs 48 to retract the pins 44 of the lock mechanisms 40a, 40b from the slots 52a. This frees the board 20, allowing the board 20 to be rotated up to the raised position. Once the pins 44 reach the slots 52b, the biasing spring 46 automatically biases the pins 44 outward and into the slots 52b thereby releasably locking the board 20 at the raised position.

In an embodiment, the board 20 may be configured to have an intermediate position that is between the first position and the second position. For example, the intermediate position may be relative to the grab bar 30 if the grab bar 30 is present. An example of the intermediate position is depicted in FIG. 1. In this example, the intermediate position may be midway between the first position and the second position, and at the intermediate position the board 20 may be oriented substantially horizontally and project perpendicularly relative to the wall 14. In this example intermediate position, the board 20 may act substantially as a table. In the case of an intermediate position, the ears 34a, 34b may include slots 52c that can receive the pins 44 similar to the slots 52a, 52b to releasably lock the board 20 at the intermediate position.

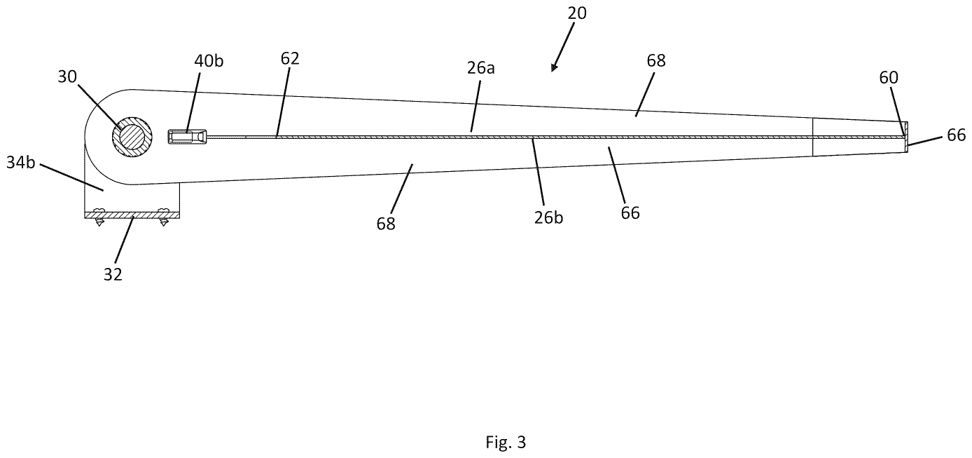

Referring to FIGS. 2 and 3, the board 20 is a plate-like structure defining the first side surface 26a and the second side surface 26b. The board 20 includes an end edge 60, an inner edge 62 (also see FIG. 4) opposite the end edge 60, and side edges 64 that are opposite one another and that extend generally from opposite ends of the end edge 60 toward the inner edge 62. The end edge 60, the inner edge 62 and the side edges 64 define a perimeter edge of the board 20. When the grab bar 30 is present, the side edges 64 are perpendicular to a longitudinal axis of the grab bar 30, and the end edge 60 and a majority portion of the inner edge 62 are parallel to the longitudinal axis.

A flange 66 may extend along at least a portion of the perimeter edge, and the flange 66 may project beyond the first side surface 26a and the second side surface 26b to define a raised lip 68 along at least a portion of the board 20. In the example illustrated in FIGS. 2-3, the flange 66 extends along the end edge 60 and the side edges 64 on each side of the board 20. As best seen in FIG. 3, the raised lip 68 is formed on both sides of the board 20 and extends above/below the first side surface 26a and the second side surface 26b. The flange 66 and the raised lip 68 are optional. However, if present, the raised lip 68 formed by the flange 66 helps to retain items on the board 20, especially when the board 20 is at an intermediate, horizontal position. The flange 66 also helps to stiffen the board 20. The flange 66 may also act as a spacer to help space the board 20 from the surface of the wall 14 at the first position or the second position.

The board 20 together with the locking mechanism may initially be separate from the grab bar 30 which may already be installed on and fixed to the wall of the shower area. In another embodiment, the grab bar 30 may be included with the board 20 and installed together or simultaneously with the board 20 to the wall of the shower area.

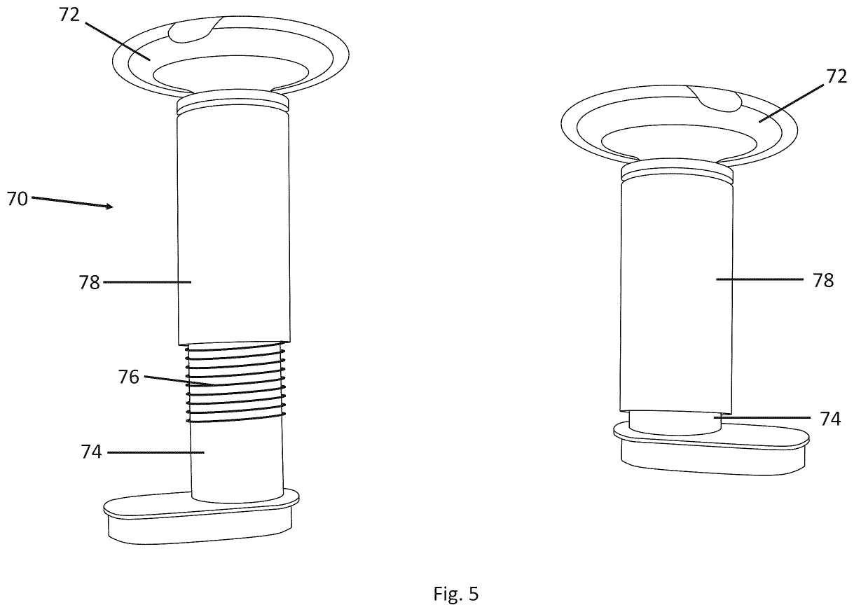

FIG. 5 depicts optional adjustable stand-offs 70 that can be secured to the board 20 (or to any magnetic board described herein) for use in spacing the board from the wall. The stand-offs 70 may be used together with or separately from the locking mechanism and/or the flange 66. The stand-offs 70 may be secured to the magnetic board or secured to the wall. In the example in FIG. 5, the stand-offs 70 include an end with a suction cup 72 attached to that end. The stand-offs 70 further include an opposite male end 74 that is externally threaded 76 and the threads telescope into a female section 78 that is internally threaded to match the external threads 76. In operation, the male end 74 can be threaded into or from the female section 78 to adjust the length of the stand-offs 70. The suction cups 72 can be secured to the wall or to the surface of the magnetic board facing the wall, with the male end 74 facing the other of the board or the surface of the fall and adjusted in length to space the board a desired distance from the wall.

FIGS. 17A and 17B depict an embodiment of a magnetic board that uses different stand-offs 80. The stand-offs 80 space the magnetic board from the wall as well as retain the magnetic board in the raised (or lowered or lateral) position. In this embodiment, the stand-offs 80 are fixed to the wall and include a neck 81 having an end with a male enlargement 82. The magnetic board includes throughholes 83 having a wide portion 84 to allow the male enlargement 82 to pass through and a narrow portion 85 that receives the neck 81. In use, the magnetic board can be raised up or lowered and the male enlargement 82 can pass through the wide portion 84 of the throughholes 83 until the neck 81 is at the narrow portion 85. To allow the throughholes 83 and the stand-offs 82 to align with one another, some movement of the magnetic board relative to the grab bar is permitted to allow the wide portion 84 and the male enlargement 82 to align with one another, and once the male enlargement 82 extends through the wide portion 84, the magnetic board can slide back down so that the neck 81 is within the narrow portion 85 thereby locking the magnetic board in the raised position. FIG. 17A shows the magnetic board swinging upward to the raised position with the stand-offs 80 vertically above the magnetic board. The stand-offs 80 may alternatively or additionally be located below the board to help retain the board at the lowered position. The stand-offs 80 may also be located to one or more sides of the board if the board is intended to swing side-to-side as described above for FIG. 15. In addition, although two stand-offs 80 are depicted, a single stand-off 80 can be used, or more than two of the stand-offs 80 can be used.

FIGS. 18A and 18B depict an embodiment of a magnetic board that uses different stand-offs 86. The stand-offs 86 space the magnetic board from the wall as well as retain the magnetic board in the raised (or lowered or lateral) position. In this embodiment, the stand-offs 86 are fixed to the wall and include a neck 87 having an end 88 that is magnetic. The end 88 may be enlarged like the male enlargement 82 in FIGS. 17A and 17B. The magnetic end 88 magnetically attracts the magnetic board securing the magnetic board in the raised (or lowered or lateral) position. FIG. 18A shows the magnetic board swinging upward to the raised position with the stand-offs 86 vertically above the magnetic board. The stand-offs 86 may alternatively or additionally be located below the board to help retain the board at the lowered position. The stand-offs 86 may also be located to one or more sides of the board if the board is intended to swing laterally side-to-side as described above for FIG. 15. In addition, although two stand-offs 86 are depicted, a single stand-off 86 can be used, or more than two of the stand-offs 86 can be used.

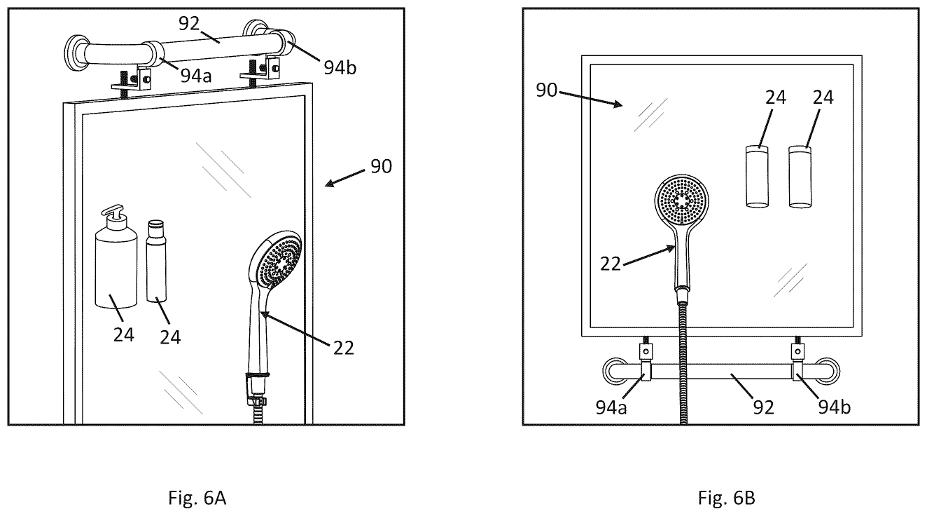

FIGS. 6A and 6B illustrate another embodiment of a magnetic board 90. The magnetic board 90 may be made partially or entirely from a magnetic material such that a portion of or the entire board 90 is magnetic. For example, the magnetic board 90 can be formed from a magnetic metal material such as a ferrous metal or a martensitic metal. In an embodiment, the magnetic board 90 can be made from a magnetic stainless steel. In an embodiment, the magnetic board 90 can have a mirror finish to allow the user to view themselves while showering. In an embodiment, like with the magnetic board 20, an entire area of a first side surface of the magnetic board 90 may be magnetic, and an entire area of a second side surface of the magnetic board 90 may be magnetic. However, in another embodiment, only the first side surface may be magnetic while the second side surface is not magnetic, or only the second side surface may be magnetic while the first side surface is not magnetic, or only a portion of the area of the first side surface and/or a portion of the area of the second side surface may be magnetic.

In FIGS. 6A and 6B, the magnetic board 90 may be secured to a grab bar 92 by first and second collars 94a, 94b. The collars 94a, 94b are rotatable relative to the grab bar 92 to allow the magnetic board 90 to swing relative to the grab bar 92 between a first or lowered position (FIG. 6A) with respect to the grab bar 92 and a second or raised position (FIG. 6B) with respect to the grab bar 92. In this embodiment, the first or lowered position is a position vertically below the grab bar 92, and the second or raised position is a position vertically above the grab bar 92, and the grab bar 92 is oriented horizontally on the shower wall. In this embodiment, the board 90 pivots about a substantially horizontal pivot axis formed by the grab bar 92 as it moves between the first and second positions. In an embodiment, a releasable locking mechanism can be provided to releasably lock the board 90 in the first or second positions. The stand-offs 70 described in FIG. 5 above may also be used. Alternatively, in an embodiment, the board 90 may remain in the first position or the second position via gravity, i.e. in FIG. 6A the board 90 may hang down from the grab bar 92 in the first position under the force of gravity, and in FIG. 6B may remain in the second or raised position without a locking mechanism and may be tilted or angled slightly toward the wall rather than being in a vertical plane.

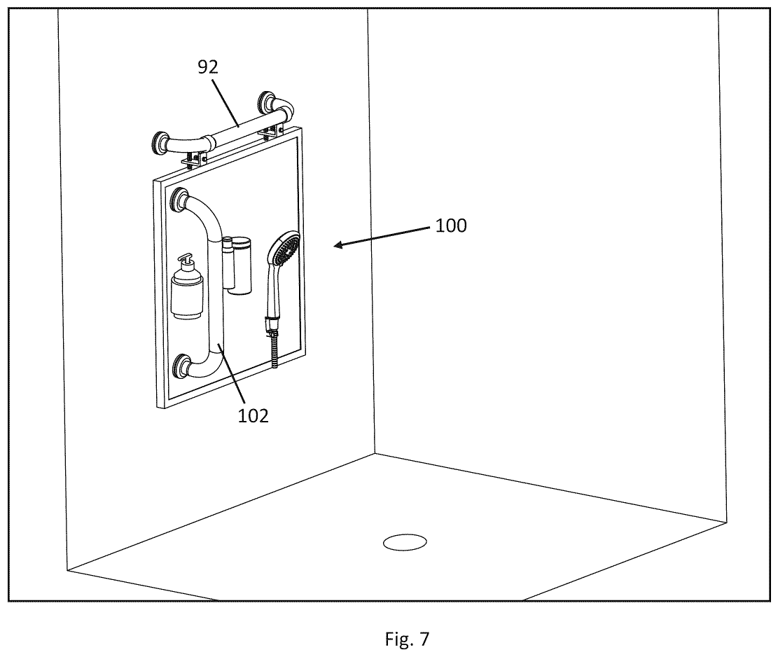

FIG. 7 depicts another embodiment of a magnetic board 100. The magnetic board 100 may be made partially or entirely from a magnetic material such that a portion of or the entire board 100 is magnetic. For example, the magnetic board 100 can be formed from a magnetic metal material such as a ferrous metal or a martensitic metal. In an embodiment, the magnetic board 100 can be made from a magnetic stainless steel. In an embodiment, the magnetic board 100 can have a mirror finish to allow the user to view themselves while showering. In an embodiment, like with the magnetic board 20, an entire area of a first side surface of the magnetic board 100 may be magnetic, and an entire area of a second side surface of the magnetic board 100 may be magnetic. However, in another embodiment, only the first side surface may be magnetic while the second side surface is not magnetic, or only the second side surface may be magnetic while the first side surface is not magnetic, or only a portion of the area of the first side surface and/or a portion of the area of the second side surface may be magnetic.

In FIG. 7, the magnetic board 100 may be generally similar in construction to the magnetic board 90 in FIG. 6A and like elements are referenced using the same reference numerals. In addition to the magnetic board 100 being secured to the grab bar 92 by the collars 94a, 94b, a second grab bar 102 may be directly attached to the magnetic board 100. The grab bar 102 may pivot with the board 100 about the axis of the grab bar 92. The grab bar 102 may be mounted vertically on the board 100 as depicted in FIG. 7 whereby the axis of the grab bar 102 is perpendicular to the axis of the grab bar 92, the grab bar 102 may be mounted horizontally on the board 100 whereby the axis of the grab bar 102 is parallel to the axis of the grab bar 92, or the grab bar 102 may be mounted at an angle on the board 100 where the axis of the grab bar 102 is at an acute angle to the axis of the grab bar 92.

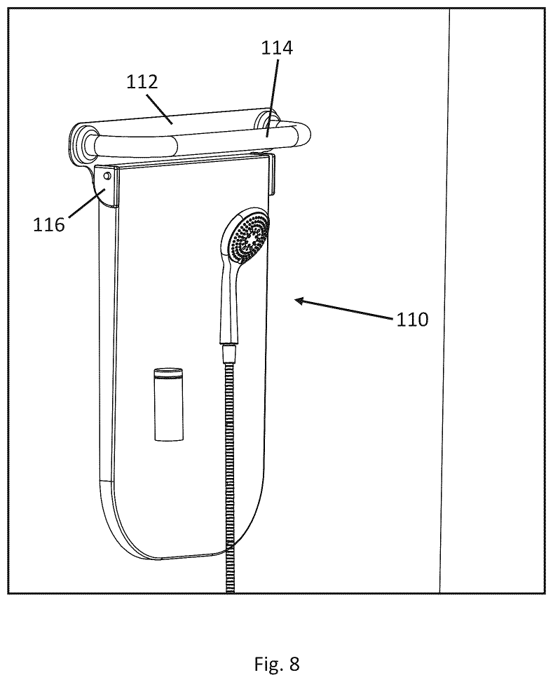

FIG. 8 depicts another embodiment of a magnetic board 110. The magnetic board 110 may be made partially or entirely from a magnetic material such that a portion of or the entire board 110 is magnetic. For example, the magnetic board 110 can be formed from a magnetic metal material such as a ferrous metal or a martensitic metal. In an embodiment, the magnetic board 110 can be made from a magnetic stainless steel. In an embodiment, the magnetic board 110 can have a mirror finish to allow the user to view themselves while showering. In an embodiment, like with the magnetic board 20, an entire area of a first side surface of the magnetic board 110 may be magnetic, and an entire area of a second side surface of the magnetic board 110 may be magnetic. However, in another embodiment, only the first side surface may be magnetic while the second side surface is not magnetic, or only the second side surface may be magnetic while the first side surface is not magnetic, or only a portion of the area of the first side surface and/or a portion of the area of the second side surface may be magnetic.

In FIG. 8, the board 110 is mounted to a bracket 112 that is fixed to the wall, and a grab bar 114 is mounted to the wall via the bracket 112. In addition, the board 110 is mounted to the ends of the grab bar 114 by one or more pivots 116 (only one pivot is visible in FIG. 8) and is positioned below the grab bar 114. A biasing spring (not visible in FIG. 8) associated with the pivot(s) 116 may act on the magnetic board 110 to resiliently bias the magnetic board 110 toward the wall. In this embodiment, the board 110 may remain in the lowered position, but may be moved away from the wall a distance to allow access to the area of the wall covered by the board 110.

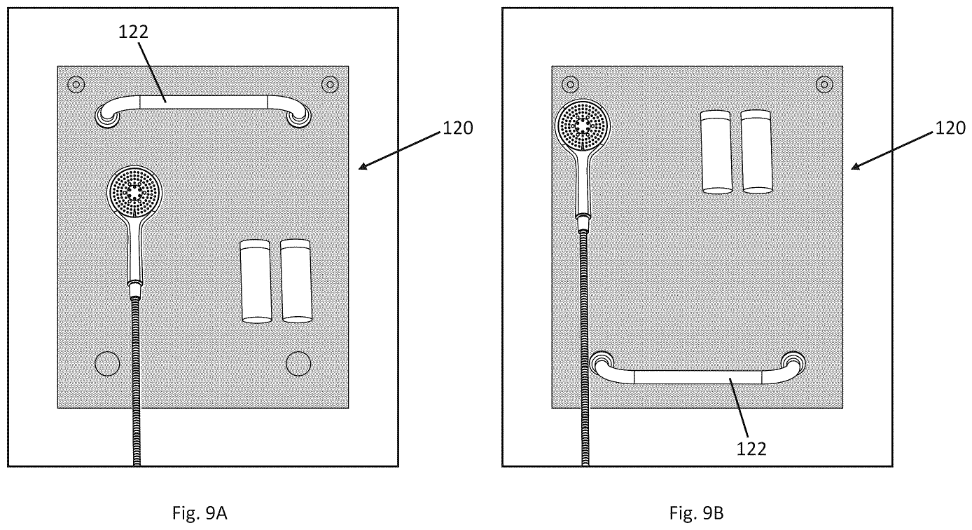

FIGS. 9A and 9B illustrate another embodiment of a magnetic board 120. The magnetic board 120 may be made partially or entirely from a magnetic material such that a portion of or the entire board 120 is magnetic. For example, the magnetic board 120 can be formed from a magnetic metal material such as a ferrous metal or a martensitic metal. In an embodiment, the magnetic board 120 can be made from a magnetic stainless steel. In an embodiment, the magnetic board 120 can have a mirror finish to allow the user to view themselves while showering. In an embodiment, like with the magnetic board 20, an entire area of a first side surface of the magnetic board 120 may be magnetic, and an entire area of a second side surface of the magnetic board 120 may be magnetic. However, in another embodiment, only the first side surface may be magnetic while the second side surface is not magnetic, or only the second side surface may be magnetic while the first side surface is not magnetic, or only a portion of the area of the first side surface and/or a portion of the area of the second side surface may be magnetic.

In FIGS. 9A and 9B, the board 120 may be formed by a perforated magnetic plate that includes perforations. The perforations may extend over an entire area of the board 120 or, in another embodiment, extend over only a portion of the area of the board 120. FIG. 9A depicts an optional grab bar 122 that may be mounted to the board 120 adjacent to the upper edge thereof, or as illustrated in FIG. 9B, the grab bar 122 may be mounted adjacent to the bottom edge thereof. In another embodiment, the grab bar 122 may be mounted adjacent to one of the side edges of the board 120.

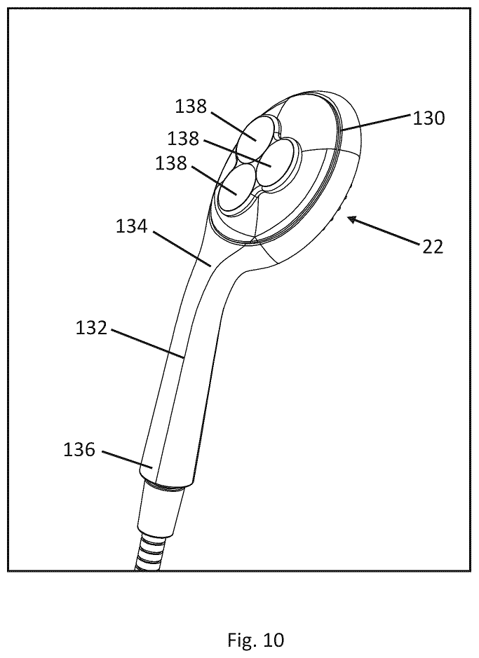

FIG. 10 illustrates an example of the hand-held shower head 22. The hand-held shower head 22 includes a shower head 130 and a handle 132 having a first end 134 attached to the shower head 130 and a second end 136 spaced from the first end 134. One or more magnets 138, for example three magnets, fixed to a back-side of the shower head 130 opposite the side of the shower head 130 from which water is discharged. The magnet(s) 138 allow magnetic attachment of the hand-held shower head 22 to any one of the magnetic boards described herein.

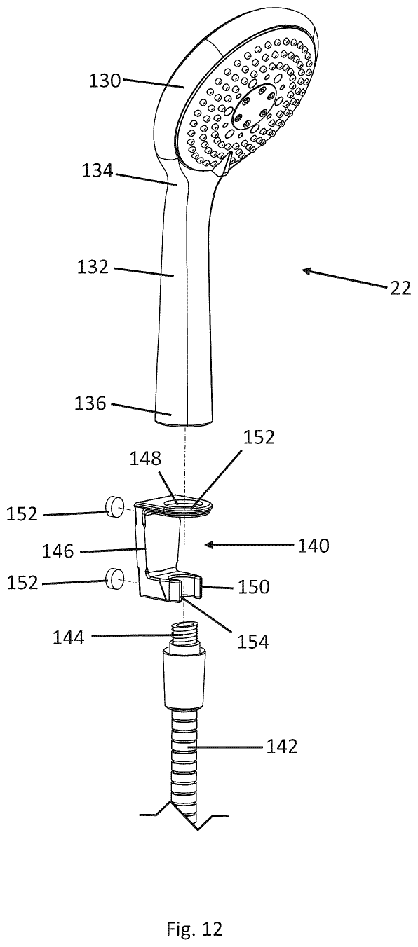

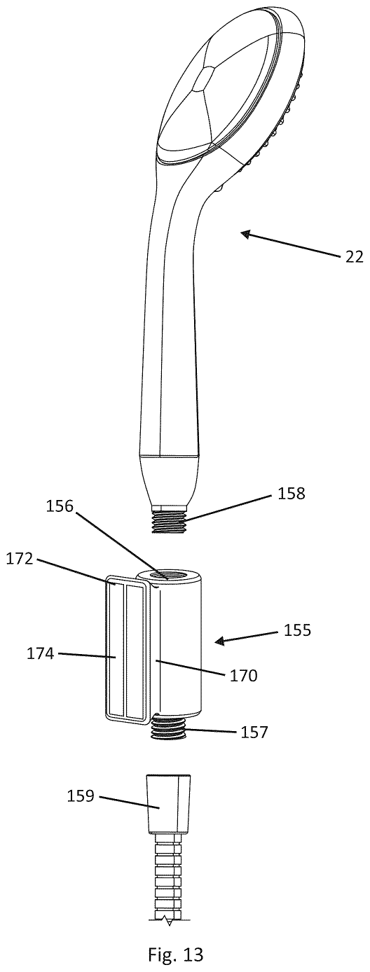

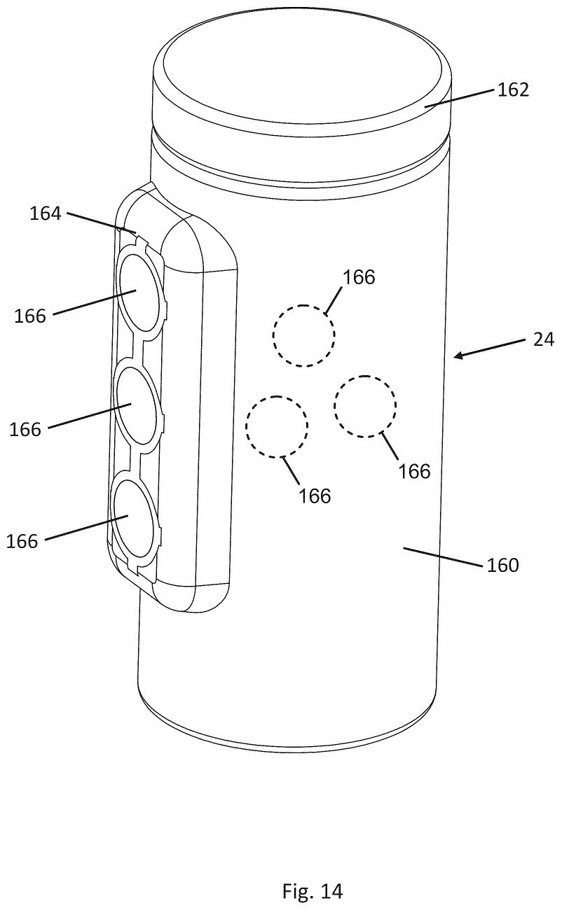

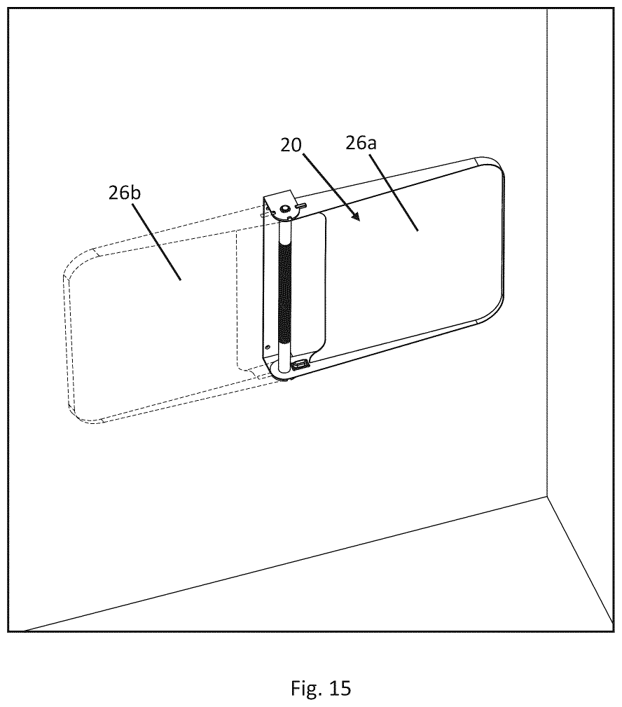

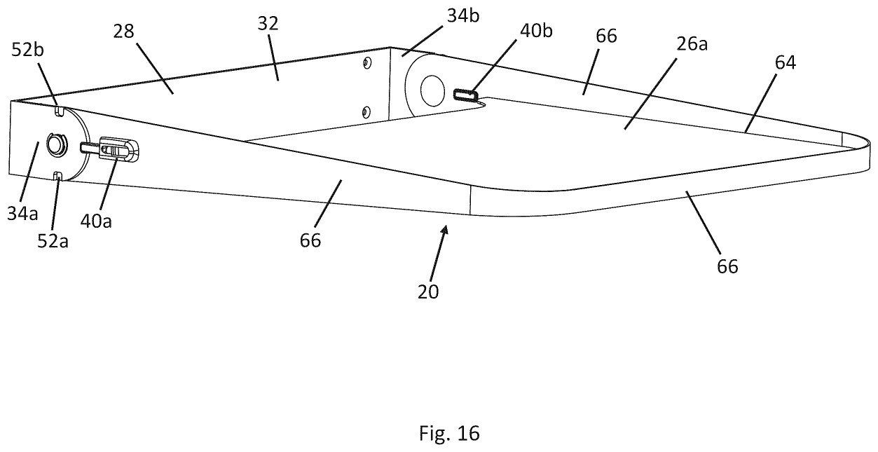

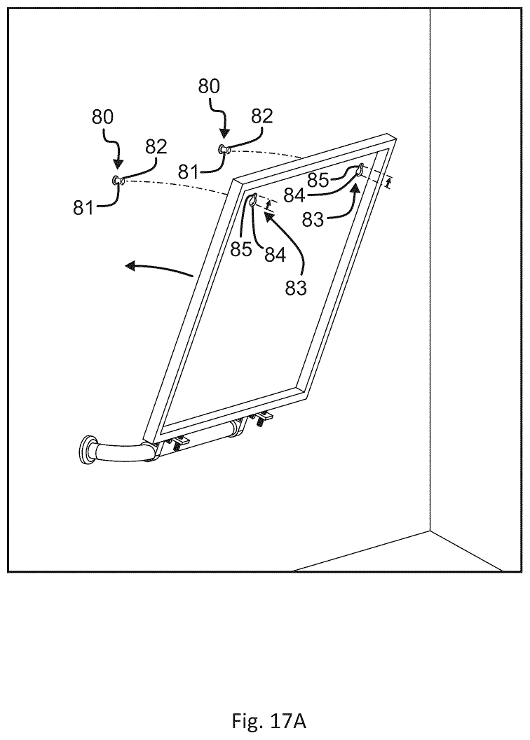

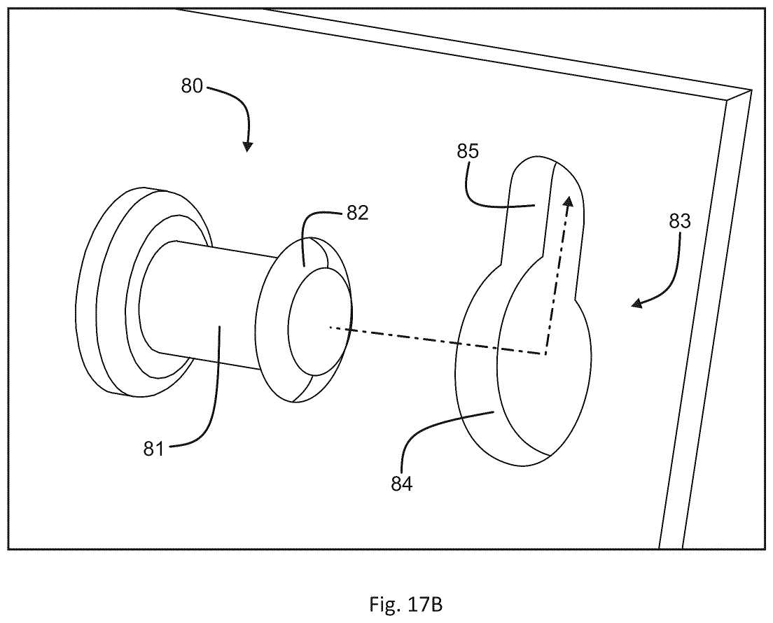

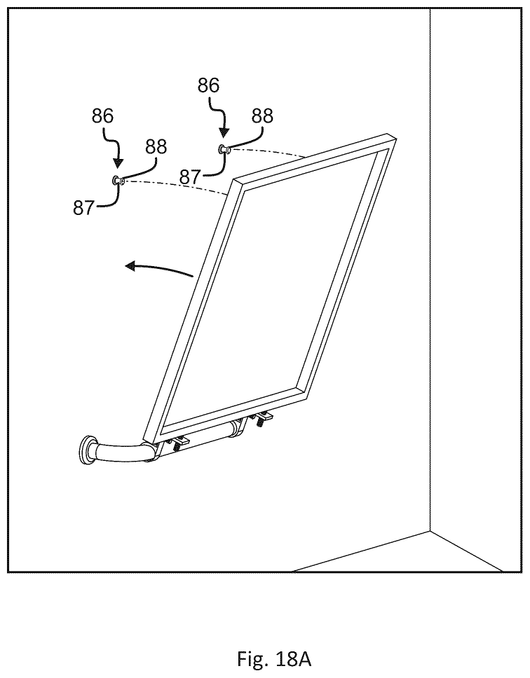

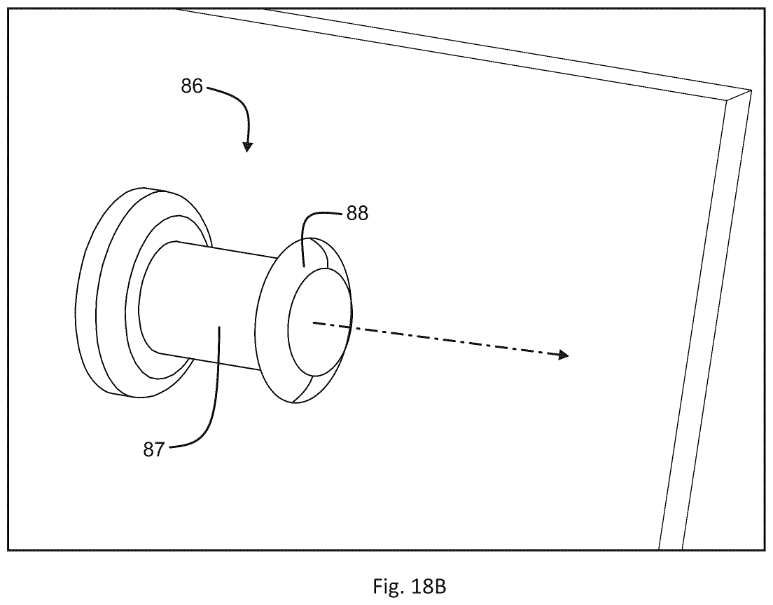

FIGS. 11 and 12 illustrate another example of the hand-held shower head 22. Elements in FIGS. 11 and 12 that are similar to elements in FIG. 10 are referenced using the same reference numerals. In this example, a mounting cuff 140 is used to magnetically attach the hand-held shower head 22 to any one of the magnetic boards described herein. The mounting cuff 140 is configured to connect to the hand-held shower head 22 via a hose 142 that supplies water to the hand-held shower head 22. The hose 142 includes a male end that is threaded 144 and threads into female threads at the end 136 of the handle 132. In the example illustrated in FIGS. 11 and 12, the mounting cuff 140 has a cuff body 146, a first flange 148 that extends from a first side of the cuff body 146, and a second flange 150 that extends from the first side of the cuff body 146 at a position spaced from the first flange 148. In addition, one or more magnets 152, for example two magnets, may be fixed to the cuff body 146 on the side thereof that is opposite the flanges 148, 150. The first flange 148 has an opening or hole 152 therethrough that is sized to allow passage of the hose 142, in particular the threaded male end 144, therethrough with the male end 144 then being connected to the second end 136 of the handle 132. The second flange 150 has a slot 154 formed therein that is sized to allow passage of the hose 142. When the hand-held shower head 22 is attached to the hose 142 and the mounting cuff 140 is mounted in position as depicted in FIG. 11, the magnet(s) 152 allow magnetic attachment of the hand-held shower head 22 to any one of the magnetic boards described herein. FIGS. 6A, 7 and 8 depict the mounting cuff 140 magnetically attaching the hand-held shower head 22 to the respective magnetic boards.

FIG. 13 depicts another example of a mounting cuff 155. Elements in FIG. 13 that are the same or similar to elements in FIGS. 11 and 12 are referenced using the same reference numerals. In this example, the mounting cuff 155 is depicted as including a body with an end with an internally threaded female opening 156 and an end with an externally threaded male protrusion 157. The mounting cuff 155 includes a fluid flow passage from the female opening 156 to the male protrusion 157 to allow water to flow through the cuff 155. The shower head 22 includes a male threaded end 158 that threads into the female opening 156 to secure the shower head 22 to the cuff 155. The hose 142 includes a female threaded end 159 that threads onto the male protrusion 157 to secure the hose 142 to the cuff 155. The cuff 155 further includes a protrusion 170 on a side thereof with a flat surface 172. One or more magnets 174 are on or in the flat surface 172 for magnetically attaching the cuff 155, and thus the shower head 22, to a magnetic board, such as any one of the magnetic boards described herein.

FIG. 14 depicts an example of the bottle 24 that can be configured to contain soap, shampoo, conditioner or other liquid/gel for use in the shower, and that is magnetically attachable to any one of the magnetic boards described herein. The bottle 24 is configured to facilitate use by users with limited mobility, such as elderly adults, or people with disabilities. The bottle 24 may be configured to be easy to squeeze or easily malleable by users to facilitate dispensing of contents therefrom. For example, the bottle 24 can be formed from a plastic, malleable material and the bottle 24 can be detached from the board and squeezed with one hand by the user or left on the magnetic board and pushed with one hand by the user while remaining attached to the magnetic board to allow liquids to be dispensed.

The bottle 24 may be provided with tactile markings that indicate its contents. For example, the bottle 24 may include tactile symbols, raised text, indented text and/or symbols, elevated designs, tactile guides or brail markings to optimize visual impaired individuals'ability to identify and decipher the contents (shampoo, conditioner, body wash, shave cream, etc.). The tactile markings may be formed in the material that forms the bottle, or the tactile markings may be formed on an element, such as a tag or sticker, that is attached to the bottle. In an embodiment, the tactile markings may be located on an area of the bottle that is not considered a high touch area to avoid the tactile markings being worn down. For example, the tactile markings may be placed on the opposite side of the bottle from where the liquid will be dispensed. In an example use case where the bottle is oriented with the dispensing end thereof facing down (to leverage the natural weight and liquid pressure to aid in smoother dispensing), the tactile markings may be located on the opposing end or “top” of the bottle. Examples of tactile markings can include a sequence of large dots, lines, or shapes including but not limited to a circle, a square, a triangle. In an embodiment, different bottles may be differentiated from one another by use of one tactile marking symbol, two tactile marking symbols or three tactile marking symbols. The tactile marking should be large enough to be easily felt, for example at least 1 cm in height and 1 cm in width. For example, assuming three different bottles and assuming that the tactile markings are dots/circles, each one of the three bottles may have a different number of circles/dots to indicate different contents: for example one bottle may have a single circle/dot, the second bottle may have two circle/dots, and the third bottle may have three circles/dots, and each circle/dot may be at least 1 cm in height and 1 cm in width for better tactility.

The bottle 24 may have an ergonomic design to facilitate gripping by a user with limited mobility. The bottle 24 may be formed from high grip or hydrophobic materials to increase a user's ability to grasp and manipulate the bottle. The bottle 24 may include wide mouth that is wider than conventional shampoo, soap and other shower item bottles, with a removable cap to make the bottle 24 easy to open and fill by removing the cap. The bottle 24 may include high-contrast, bright, and bold contrasting colors for individuals with low vision to easily distinguish identify and decipher the contents (shampoo, conditioner, body wash, shave cream, etc.). For example, in the example above of three different bottles, each bottle may have a unique combination of body and cap colors. For example, the bottle bodies may have the same color, but the caps on each bottle may have different colors to denote different contents. In another embodiment, the bottle bodies may have different colors from one another, but the caps may have the same colors. In still another embodiment, the bottle bodies may have different colors from one another, and the caps may also have different colors from one another (for each bottle, the color of the bottle body and the color of the cap may be the same as one another).

In FIG. 14, the bottle 24 is depicted as including a substantially cylindrical main body 160 with a removable lid 162. The lid 162 may be attached by threads to the main body 160. The bottle 24 includes a material dispensing end which in an embodiment is the end with the lid 162 and which is configured to dispense a material from the bottle when a sufficient force is applied to the main body 160. For example, the lid 162 can include a one-way dispending valve 163 built therein from which material contained in the bottle 24 may be discharged when a sufficient force is applied to the main body 160. The valve 163 may have an open and closed position, or provided with a device that opens or closes the valve 163, with material dispensing being permitted in the open position and material dispensing being prevented in the closed position. A magnet holder 164 is attached to the main body 160. One or more magnets 166, for example three magnets, are mounted on and secured to the magnet holder 164. The magnet(s) 166 allow magnetic attachment of the bottle 24 to any one of the magnetic boards described herein. In another embodiment, instead of including the magnet holder 164, or in addition to the magnet holder 164, one or more of the magnets 166 can be embedded or molded within the material of the bottle 24 as depicted in broken lines in FIG. 14 to form a one-piece construction with the bottle. For example, the magnet(s) 166 can be embedded or molded within the material forming the main body 160 of the bottle 24. If the magnet holder 164 is not used, the embedded magnet(s) 166 may be located on the bottle 24 at the location of the magnet holder 164 in FIG. 14 or the embedded magnet(s) may be located on the bottle 24 at the location depicted in FIG. 14 or at any other location on the bottle 24. The bottle 24 further includes an end 168 opposite the dispensing end, with the end defining an end surface (not shown, but facing downward in FIG. 14). The end surface can include the tactile marking(s) described above. As described above, the bottle 24 may be mounted on the magnetic board in an orientation where the dispensing end with the dispending valve 163 faces downward, with the end 168 thereby forming the upper end of the bottle 24 as mounted on the magnetic board. In this orientation, a user can push on the main body 160 while the bottle 24 is mounted on the board and thereby cause the dispensable material to be dispensed from the bottle 24 via the valve 163. This orientation and location of the bottle is easier for those users who may not be able to grip and/or squeeze the bottle 24 using their hand(s).

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A magnetic shower item mounting system comprising:
a grab bar mounted to a shower wall;
a magnetic board movably mounted to the grab bar, the magnetic board is movable relative to the grab bar between a first position relative to the grab bar and a second position relative to the grab bar;
the magnetic board having a first side surface and a second side surface, in the first position the first side surface faces away from the shower wall and the second side surface faces the shower wall, and in the second position the second side surface faces away from the shower wall and the first side surface faces the shower wall; and
the magnetic board is formed from a magnetic material, an entire area of the first side surface is magnetic, and an entire area of the second side surface is magnetic; whereby a shower item having at least one magnet disposed thereon can be magnetically attached anywhere on the first side surface or on the second side surface.

2. The magnetic shower item mounting system of claim 1, further comprising a releasable locking mechanism engageable with the magnetic board, the locking mechanism is configured to releasably lock the magnetic board at the first position and configured to releasably lock the magnetic board at the second position.

3. The magnetic shower item mounting system of claim 1, wherein the first position is vertically below the grab bar and the second position is vertically above the grab bar.

4. The magnetic shower item mounting system of claim 1, wherein the first position is laterally to a first side of the grab bar and the second position is laterally to a second side of the grab bar.

5. The magnetic shower item mounting system of claim 1, wherein the magnetic board has an intermediate position relative to the grab bar, the intermediate position is between the first position and the second position.

6. The magnetic shower item mounting system of claim 1, wherein the magnetic board includes a perimeter edge and a flange that extends along the perimeter edge, and the flange projects beyond the first side surface and the second side surface.

7. The magnetic shower item mounting system of claim 6, wherein the perimeter edge includes side edges that are perpendicular to a longitudinal axis of the grab bar and an end edge that is parallel to the longitudinal axis, and the flange extends along the side edges and the end edge.

8. The magnetic shower item mounting system of claim 1, wherein the entire area of the first side surface and the entire area of the second side surface of the magnetic board are perforated.

9. The magnetic shower item mounting system of claim 1, further comprising a second grab bar, the second grab bar is mounted on the magnetic board.

10. The magnetic shower item mounting system of claim 1, further comprising a shower item having at least one magnet disposed thereon, the shower item is magnetically attachable to either the first side surface or to the second side surface of the magnetic board.

11. The magnetic shower item mounting system of claim 10, wherein the shower item comprises a bottle.

12. A magnetic shower item mounting system comprising:
a magnetic board movably mounted to a shower wall, the magnetic board is movable relative to the shower wall between a first position relative to the shower wall and a second position relative to the shower wall;
the magnetic board having a first side surface and a second side surface, in the first position the first side surface faces away from the shower wall and the second side surface faces the shower wall, and in the second position the second side surface faces away from the shower wall and the first side surface faces the shower wall; and
the magnetic board is formed from a magnetic material, an entire area of the first side surface is magnetic, and an entire area of the second side surface is magnetic; whereby a shower item having at least one magnet disposed thereon can be magnetically attached anywhere on the first side surface or on the second side surface.

13. The magnetic shower item mounting system of claim 12, further comprising a releasable locking mechanism engageable with the magnetic board, the locking mechanism is configured to releasably lock the magnetic board at the first position and configured to releasably lock the magnetic board at the second position.

14. The magnetic shower item mounting system of claim 12, wherein the magnetic board has an intermediate position relative to the wall, the intermediate position is between the first position and the second position.

15. The magnetic shower item mounting system of claim 12, wherein the magnetic board includes a perimeter edge and a flange that extends along the perimeter edge, and the flange projects beyond the first side surface and the second side surface.

16. The magnetic shower item mounting system of claim 15, wherein the perimeter edge includes side edges that are perpendicular to a surface of the shower wall and an end edge that is parallel to the surface of the shower wall, and the flange extends along the side edges and the end edge.

17. A magnetic shower item mounting system comprising:
a magnetic board having a first side surface and a second side surface, the magnetic board is formed from a magnetic material whereby at least one of the first side surface or the second side surface is magnetic;
a hand-held shower head that includes a shower head and a handle having a first end attached to the shower head and a second end spaced from the first end;
a mounting cuff, the mounting cuff is configured to mount to a shower head and is configured to mount to a hose; and
one or more magnets on the mounting cuff.

18. The magnetic shower item mounting system of claim 17, wherein the mounting cuff includes an internally threaded female opening at one end and an externally threaded male protrusion at a second end, and a fluid flow passage through the mounting cuff from the internally threaded female opening to the externally threaded male protrusion.

19. A mounting cuff usable in a magnetic shower item mounting system, comprising:
a body, an internally threaded female opening at one end of the body, an externally threaded male protrusion at a second end of the body, and a fluid flow passage through the body from the internally threaded female opening to the externally threaded male protrusion;
and
one or more magnets disposed on the body, whereby the magnets magnetically attach the body of the mounting cuff to a magnetic board of the magnetic shower item mounting system.
